(19) United States
(12) Patent Application Publication
(10) Pub. No.: US 2004/0125606 A1
(43) Pub. Date: Jul. 1, 2004

(54) Box type sensor lamp

(76) Inventor: Kang-Ling Hwang, Taipei City (TW)

Correspondence Address: BACON & THOMAS, PLLC, 625 SLATERS LANE, FOURTH FLOOR, ALEXANDRIA, VA, 22314

(21) Appl. No.: 10/327,877

(22) Filed: Dec. 26, 2002

(51) Int. Cl. B60Q 3/04

(52) U.S. Cl. 362/362

(57) ABSTRACT

The box type sensor lamp has a sensing device and a lamp set mounted as a combination in a box, it includes the box, the sensing device and the lamp set. Wherein the box is comprised of a main body and a lifting-opening portion, the lifting-opening portion is pivotally provided on the box; the main body and the lifting-opening portion have therein receiving spaces for inserting and fixed mounting of the sensing device and the lamp set therein; the lifting-opening portion is provided at the corresponding locations therein to those of the lamp set and the sensing device with holes and an insertion slot, the box type sensor lamp thus is completed.

### BACKGROUND OF THE INVENTION

1. Field of the Invention

The present invention is related to a box type sensor lamp, and especially to a box type sensor lamp that can get an effect of being easy for cleaning and maintaining and of having beautified space by combination of a sensing device with a box; the lamp is suitable for structures of box type sensor lamps of larger scope of usage.

2. Description of the Prior Art

Earlier sensor lamps are comprised each of a sensing device “A” and a searchlight “B” (as shown in FIG. 1). The sensing device “A” and the searchlight “B” are fixed on a wall to detect moving things within the detecting range of the sensing device “A”, when the sensing device “A” senses a moving thing, it activates the searchlight “B”. Such a sensor lamp can continuously sense and activate and timely extinguish the searchlight “B”.

However, by the fact that the above stated searchlight “B” is fixed on a wall by using a “U” shaped bracket, it can thereby only do angular adjustment in turning down and up, the angle and the range of searching are quite limited. And more, the sensing device “A” is generally directly provided beneath the searchlight “B” or is fixed at some other suitable location on the wall; by virtue that the sensing device “A” can only do the adjustment of sensitivity when in use but is unable to do the adjustment of sensing angle, it is quite inconvenient in use; the detecting range and effect of it is limited. Thereby, there has been another kind of sensor lamp developed to be adjustable in sensing angle and incidence angle.

Referring to FIG. 2 which shows the aforesaid another kind of sensor lamp, wherein the sensor lamp is shown to have the sensing device “A” and the searchlight “B” fixed by using a fixing seat “D”; the sensing device “A” is pivotally provided beneath the fixing seat “D”, and the searchlight “B” is pivotally provided above the fixing seat “D”. In this mode, the sensing device “A” and the searchlight “B” can do angular adjustment in turning down and up as well as rightward and leftward.

It can be seen from the above stated, the functions of the sensor lamps used presently have been developed to a degree to surely meet the requirements of users, but the entire appearances of them are complicated, they are more time consuming in cleaning and maintenance, and the entire appearances of them are subjected to giving larger feeling of terror, and subjected to destruction of their entire esthetic space designing.

### SUMMARY OF THE INVENTION

Accordingly, in view of the above stated inconvenience and defects of the conventional sensor lamps, the inventor of the present invention developed a box type sensor lamp to get rid of the defects that the conventional sensor lamps tend to have based on his professional experience of years in studying, designing and manufacturing same kind of products and after hard study as well as repeated experiments and tests.

The box type sensor lamp of the present invention at least includes a box, a sensing device and a lamp set. Wherein the box is comprised of a main body and a lifting-opening portion; the lifting-opening portion is pivotally connected with the main body, the main body and the lifting-opening portion have therein receiving spaces for fixed mounting of the sensing device and the lamp set; the lifting-opening portion is provided at the corresponding locations therein to those of the lamp set and the sensing device with holes and an insertion slot, the box type sensor lamp thus is completed.

The primary object of the present invention is to make fixed mounting of the sensing device and the lamp set in the box to get an effect of being easy for cleaning and maintaining and of having beautified space; thereby, the lamp is suitable for larger scope of usage.

The present invention will be apparent in its contents and effects it can get after reading the detailed description of the preferred embodiment thereof in reference to the accompanying drawings.

### BRIEF DESCRIPTION OF THE DRAWINGS

FIG. 1 is a perspective view showing the appearance of a conventional sensor lamp;

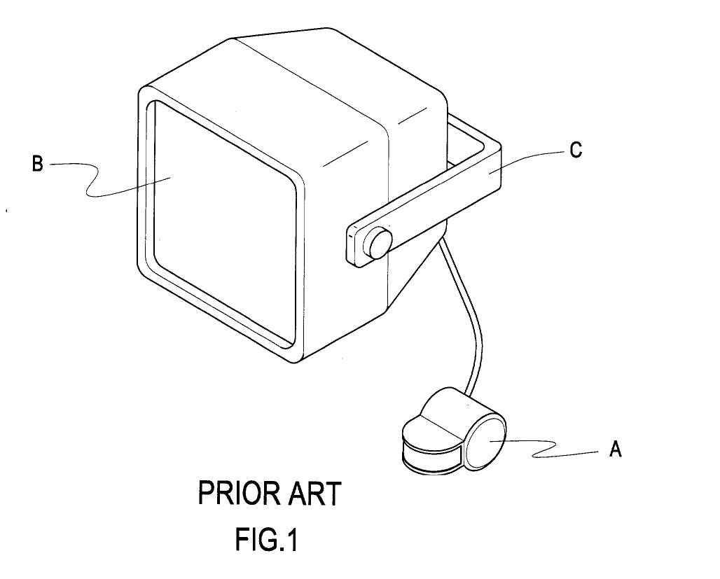

FIG. 2 is a perspective view showing the appearance of another conventional sensor lamp;

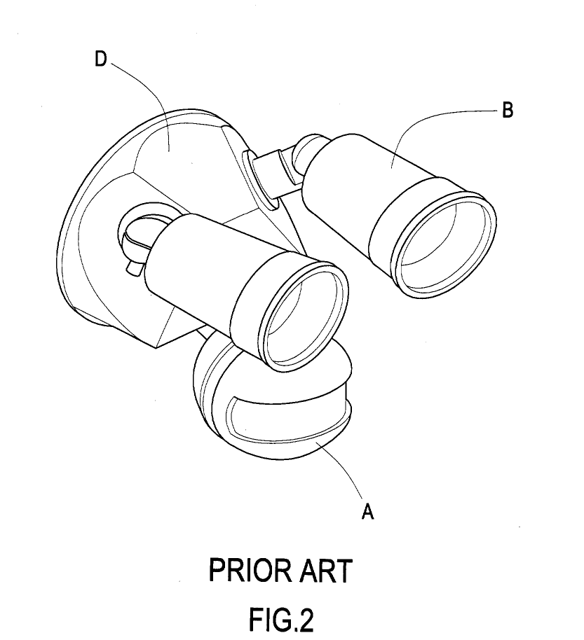

FIG. 3 is a perspective view showing the appearance of the present invention after assembling;

FIG. 4 is an analytic schematic view showing the structure of the present invention;

FIG. 5 is a schematic perspective view showing the lamp set of the present invention in assembling;

FIG. 6 is a circuit diagram used in the present invention.

### DETAILED DESCRIPTION OF THE PREFERRED EMBODIMENT

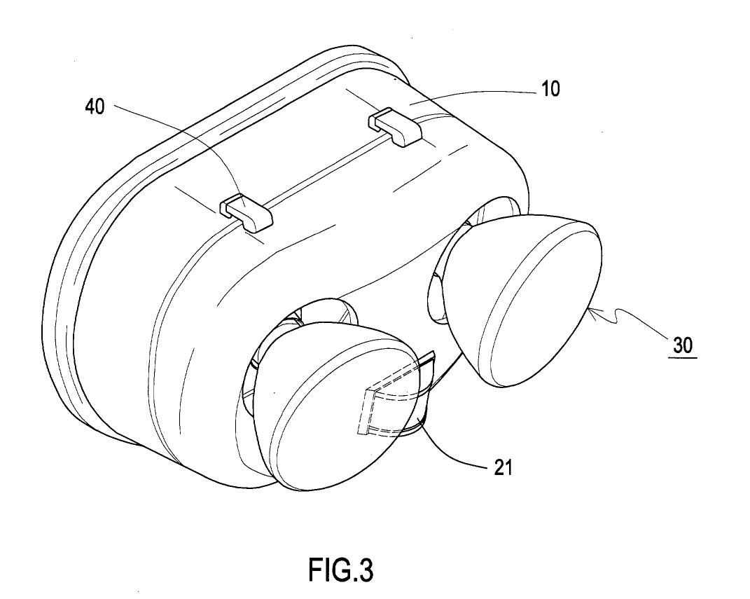

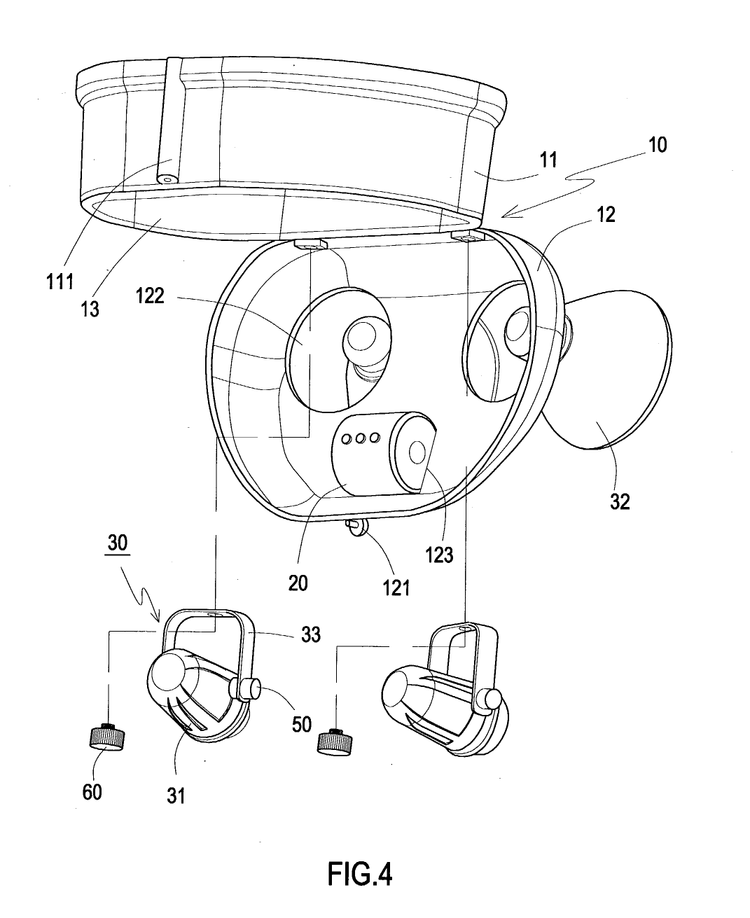

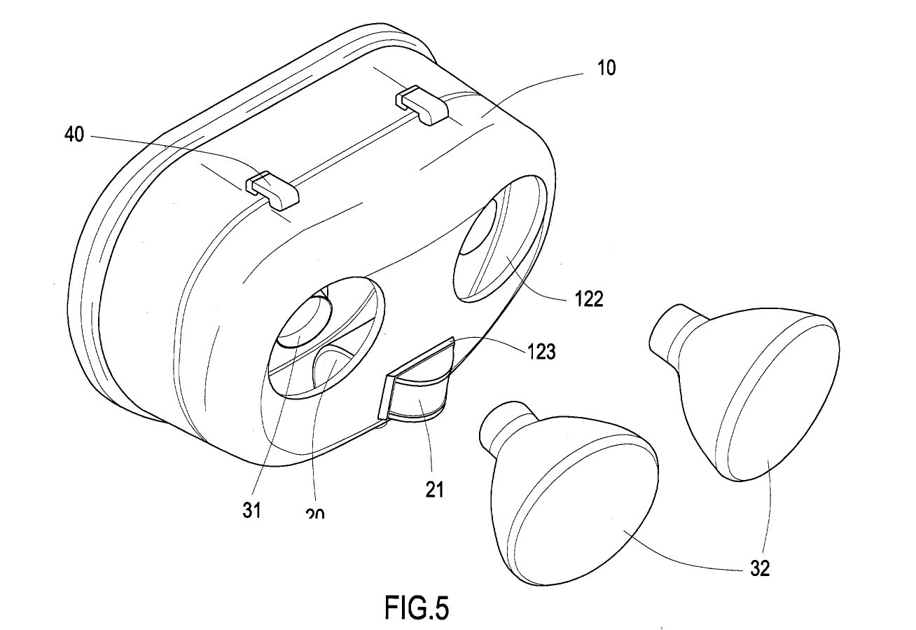

Referring to FIGS. 3-5, the sensor lamp of the present invention at least includes a box 10, a sensing device 20 and a lamp set 30. Wherein the box 10 is comprised of a main body 11 and a lifting-opening portion 12; the lifting-opening portion 12 is pivotally connected with the main body 11 by using a pivot connecting members 40 in order to obtain the function of opening and closing on the main body 11. The opening side of the lifting-opening portion 12 is provided further with a movable engaging piece 121; while the main body 11 is provided thereon with an engaging portion 111 for engaging therewith and fixing thereon of the movable engaging piece 121. In this way, the lifting-opening portion 12 can get the effect of opening and closing on the main body 11.

The main body 11 and the lifting-opening portion 12 have therein receiving spaces 13 for fixed mounting of the sensing device 20 and the lamp set 30 therein; the lifting-opening portion 12 is provided at the corresponding locations therein to those of the lamp set 30 and the sensing device 20 with holes 122 and an insertion slot 123 for positioning of the lamp set 30 and the sensing device 20 respectively, thus the box type sensor lamp is completed.

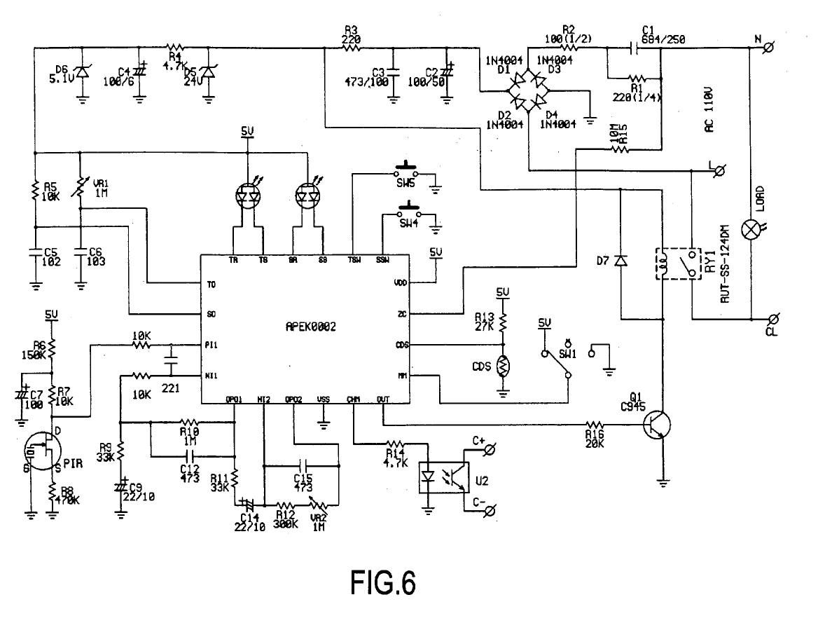

The sensing device 20 is fixedly inserted in the insertion slot 123 of the lifting-opening portion 12, it is provided with a control circuit capable of adjustment of sensitivity of detecting, setting of activating of the light source and control of a device for situation displaying (referring to FIG. 6), thereby it can continuously sense moving things.

The lamp set 30 is comprised of a plurality of lamp seats 31 and lamps 32, the lamp seats 31 each is provided with a lamp bracket 33, the lamp seats 31 and the lamp brackets 33 are pivotally fixed by using locking members 50, so that the lamp seats 31 can do angular adjustment in turning down and up. The lamp brackets 33 are pivotally mounted in the receiving spaces 13 by using fixing members 60, the fixing members 60 can allow the lamp seats 31 to do angular adjustment in turning rightward and leftward.

The lamps 32 are locked from outside toward the inside of the lifting-opening portion 12 onto lamp seats 31, and the best incidence ranges of the lamps 32 are suitably adjusted.

In using of the present invention, when in sensing of the sensing device 20 on moving things, a sensing means 21 detecting a moving thing can immediately lighten the lamp set 30 through activating of the control circuit to make the lamp set 30 irradiate within a defined scope.

One thing worth mentioning, the present invention not only can get the object of combination of the sensing device 20 with the lamp set 30 by using the box 10, the box 10 can also make the present invention get an effect of being easy for cleaning and maintaining and of having beautified space.

The names of the members stated above and the drawings shown are only for illustrating a preferred embodiment of the present invention, and not for giving any limitation to the scope of the present invention. It will be apparent to those skilled in this art that various equivalent modifications or changes without departing from the spirit and the space mode of this invention can be made to the elements of the present invention and also fall within the scope of the appended claims.

Having thus described the technical structure of my invention with practicability and novelty,

What I claim as new and desire to be secured by Letters Patent of the United States are:

1. A box type sensor lamp comprising a sensing device and a lamp set, said sensor lamp is characterized by that:
said sensing device and said lamp set are mounted as a combination in a box, said box is provided with holes and an insertion slot for inserting and fixing of said sensing device and said lamp set.

2. The box type sensor lamp as stated in claim 1, wherein
said box is comprised of a main body and a lifting-opening portion; said lifting-opening portion is pivotally connected with said main body, said holes and said insertion slot for inserting and fixing of said sensing device and said lamp set are provided in said lifting-opening portion.

3. The box type sensor lamp as stated in claim 1, wherein
said lamp set is comprised of a plurality of lamp seats and lamps, said lamp seats each is provided with a lamp bracket, and is pivotally and fixedly provided in said box by using said lamp bracket.

4. The box type sensor lamp as stated in claim 2, wherein
an opening side of said lifting-opening portion is provided with a movable engaging piece; while said main body is provided thereon with an engaging portion for engaging therewith and fixing thereon of said movable engaging piece.
